(19) United States
(12) Patent Application Publication
(10) Pub. No.: US 2004/0005374 A1
(43) Pub. Date: Jan. 8, 2004

(54) Creating objects through X and Z movement of print heads

(76) Inventors: Subhash Narang, Palo Alto, CA (US); Phillipe Guerit, Redwood City, CA (US); Susanna Ventura, Los Altos, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/438,678

(22) Filed: May 14, 2003

Related U.S. Application Data
(60) Provisional application No. 60/381,416, filed on May 16, 2002.

(51) Int. Cl. B29C 41/02

(52) U.S. Cl. 425/375

(57) ABSTRACT

Methods and devices for creating three-dimensional objects using selective deposition, wherein deposition is accomplished by moving one or more deposition nozzles in X and Z axes, but not in a Y axis. Three dimensionality is accomplished by moving the work surface in the Y axis.

### PRIORITY

This application claims priority to U.S. provisional application 60/381416 filed May 16, 2002.

### FIELD OF THE INVENTION

The field of the invention is rapid prototyping.

### BACKGROUND OF THE INVENTION

Many methods for producing models via rapid prototyping are known. Such methods include stereolithography (“SL”), selective laser sintering (“SLS”), laminated object manufacturing (“LOM”), fused deposition, solid ground curing, rapid tooling, and methods employing ink jet techniques. Methods employing ink jet techniques generally involve shooting droplets of liquid-to-solid compositions to form a layer of a rapid prototype model. Known rapid prototyping ink jet techniques include: Sanders ModelMaker™ in which an inkjet capable of x-y motion dispenses thermoplastic and wax materials; “Multi-Jet Modeling” (“MJM”) which utilizes a print head comprising a large number (around 95) of molten plastic dispensing elements in a print head that moves along a single axis; and “Three-Dimensional Printing” in which a two-axis inkjet head having numerous individual jets sprays a binder fluid over an unbound powder layer.

The reader is also directed to published PCT applications, serial numbers PCT/US98/18869, PCT/US98/25088, and PCT/US00/11524, the disclosures of which are incorporated herein by reference.

### SUMMARY OF THE INVENTION

A method of creating a three-dimensional object using selective deposition, comprises: (a) providing a substantially planar substrate defining an X and a Y axis; (b) moving a print head back and forth along the X axis, but not along the Y axis; and (c) moving the print head back and forth in a Z axis, where the Z axis is orthogonal to both the X axis and the Y axis.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a selective deposition device according to the present invention.

FIG. 2 is a detail view of the nozzle assembly of FIG. 1.

FIG. 3 is a schematic of a method for creating a three-dimensional object using selective deposition.

### DETAILED DESCRIPTION

Printing Machine and Methods

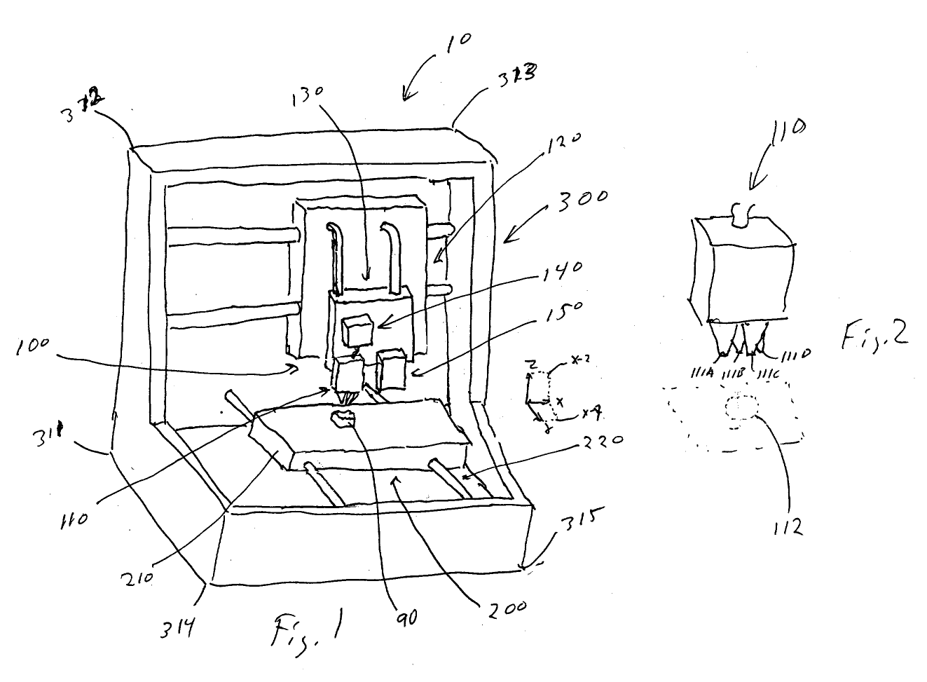

In FIG. 1, a selective deposition device 10 generally comprises deposition assembly 100, platen/work surface assembly 200, and support assembly 300. Deposition assembly 100 comprises nozzle assembly/print head 110, nozzle horizontal movement assembly 120, nozzle vertical movement assembly 130, deposition material feed assembly 140, and curing assembly 150. Platen assembly 200 comprises platen 210 and platen horizontal movement assembly 220. Support assembly 300 includes rear lower left corner 311, rear upper left corner 312, rear upper right corner 313, front lower left corner 314, and front lower right corner 315.

In FIG. 2, nozzle assembly 110 comprises four nozzles (111a, 111b, 111c, and 111d) directed toward a common deposition point 112. Nozzle assembly 110 is adapted to move in a vertical plane. Platen 210 (FIG. 1) is adapted to move in a horizontal plane, which is substantially perpendicular to the movement plane of nozzle assembly 110. Device 10 is used to produce work piece/model 90. This is typically accomplished through the use of a computer to drive device 10 to directly write/selectively deposit multiple successive layers of a photocurable deposition material onto platen 210, until model 90 is complete. During production of model 90, nozzles 111(a-d) of nozzle assembly 110 are used to selectively deposit one or more deposition materials/liquid-to-solid compositions on platen 210 or on deposition materials previously deposited on platen 210. Deposition will generally be accomplished one layer at a time such that the following sequence occurs: a) nozzle assembly 110 is positioned vertically relative to platen 210 via nozzle vertical movement assembly 130; b) nozzle assembly 110 is moved horizontally via nozzle horizontal movement assembly 120 to deposit a “line” of material (deposition may occur in increments along the line); c) once a line is complete, platen 210 is moved horizontally via platen horizontal movement assembly 220 to position model 90 in preparation for deposition of the next line; d) steps b and c are repeated until an entire layer is complete at which point the sequence is repeated until model 90 is complete. In alternative embodiments, steps b and c may be reversed, and/or layers and lines may be completed in piecemeal fashion.

The term “successive layers” is used herein to mean layers of build materials that are sequentially deposited on a build. It is not necessary that a previous layer be completely solidified or otherwise cured before the subsequent layer is added, and indeed it is generally advisable that the subsequent layer is added before the previous layer is fully cured. This improves inter-layer bonding. On the other hand, if a layer of build material is deposited on the build, and then additional build material is added before any substantial curing of the previously deposited material takes place, then both the previously deposited and additionally deposited build material are considered herein to comprise the same layer.

For the sake of clarity, directions relating to movement of portions of device 10 will be described in relation to an orthogonal coordinate system having its origin at corner 311, and being characterized by an X axis extending generally parallel to a line passing through corners 312 and 313, a Y axis extending generally parallel to a line passing through corners 311 and 314, and a Z axis extending generally parallel to a line passing through corners 311 and 312. Movement from left to right or right to left is described herein as movement along the X axis. Movement from front to back or back to front is described herein as movement along the Y axis, and movement from bottom to top or top to bottom is described herein as movement along the Z axis. The triangle formed by corners 311, 312, and 313 is parallel to or coplanar with the X-Z plane, and the triangle formed by corners 311, 314, and 315 is parallel to or coplanar with the X-Y plane. Movement constrained to a plane parallel to or coplanar with the X-Z plane will be referred to as movement within the X-Z plane. Similarly, movement constrained to a plane parallel to or coplanar with the X-Y plane will be referred to as movement within the X-Y plane.

Device 10 is preferably adapted to be usable in an office environment. As such, preferred embodiments would be small enough to fit on a desktop, create little noise, operate at ambient temperature and pressure, have no requirement for a particularly clean environment, and would operate 110 volts or other line voltage. It is also preferred that device 10 not generate any hazardous emissions, not have any dangerous temperatures on external parts, and not be a hazard in any other manner. Still further, preferred devices would be sold at a retail price of less than about $5000 in 2002 US dollars. The low cost, unheard of in the prior art for a three dimensional printing device, is made possible because the print head(s) move in only the X and Z axes, and not substantially in the Y axis. This feature facilitates adaptation of mass-produced two-dimensional printers to accomplish three-dimensional printing.

The term “three-dimensional object” is used herein to mean any structure that substantially retains its intended function and shape when removed from an external support. Thus, a thin film such as that deposited on a piece of glass is herein generally considered not to be a three-dimensional object because it tends to lose its intended functionality and/or shape as it chips or peels away from the glass. A thick film such as a sheet of aluminum foil, on the other hand, is herein considered to be a three-dimensional object because it retains its shape and function long after it is removed from any roller or other external support employed during its production.

Deposition assembly 100 is used to deposit and cure deposition material in the appropriate locations on platen 210 and model 90. Deposition is accomplished primarily via nozzle assembly 110 (positioned via nozzle horizontal movement assembly 120 and nozzle vertical movement assembly 130), and deposition feed assembly 140. If curable deposition materials are to be used, deposition assembly 100 preferably includes curing assembly 150 to facilitate the curing of any such materials.

In FIG. 2, nozzle assembly 110 comprises four nozzles (111a, 111b, 111c, and 111d) directed toward a common deposition point 112. The use of multiple nozzles provides numerous advantages. One such advantage is that a given nozzle can be dedicated to a particular material to facilitate the use of multiple deposition materials in the formation of model 90. Another advantage is that the nozzles can have different characteristics, particularly in regard to the manner in which they deposit material. Thus, one nozzle may be able to deposit material more accurately than another nozzle, and/or one nozzle may be able to deposit material more quickly than another nozzle.

The deposition materials to be used will generally have an impact on the characteristics of the nozzles to be used. Those skilled in the art will appreciate that relatively more viscous deposition materials may require a larger nozzle, some nozzles may need to be heated, and so forth. All types of practical print materials are contemplated herein, whether or not presently known.

Nozzle horizontal (X) movement assembly 120 and nozzle vertical (Z) movement assembly 130 are each adapted to move nozzle assembly 110 in a vertical plane (the X-Z plane). It is contemplated that movement assemblies previously adapted for use in inkjet printers are particularly suited for this purpose. When used in such ink jet printers, such assemblies typically move a print head through a horizontal plane rather than the vertical nozzle movement plane of device 10.

Deposition material feed assembly 140 provides deposition material to nozzle assembly 110 and is preferred to comprise one or more reservoirs adapted to hold the deposition material.

Curing assembly 150 is typically a visible light source if the deposition material is photo-curable. In such an instance the intensity of the light source should be high enough to illuminate/bind/solidify each layer of model 90. It is contemplated that other energy sources may be used such that model 90 is cured/solidified by non-visible light, heat and/or radiation. It is also contemplated that curing assembly 150 may provide a catalyst or something else other than energy to start or facilitate the curing of deposition materials. If a visible light source is used, it is contemplated that light emitting diodes may be advantageously used.

“Visible light” is considered herein to be electromagnetic radiation with wavelengths ranging from 4×103 A to about 7.7×103 A. “Near infrared light” or “near IR light” is electromagnetic radiation with wavelengths ranging from 7.5×103 A to about 30×103 A. “Actinic radiation” is radiation capable of initiating photochemical reactions.

It is contemplated that using the same movement assemblies used to position nozzle assembly 110 to position curing assembly 150 may be advantageous. One contemplated advantage is that curing can be accomplished incrementally such that curing is accomplished one layer, one line, or a portion of a line at a time. Another contemplated advantage is that curing can be performed very quickly after deposition occurs, possibly within minutes, or preferably within five seconds, of deposition.

As previously discussed platen assembly 200 comprises platen 210 and platen horizontal movement assembly 220. Platen horizontal movement assembly is adapted to allow platen 210 to move in a horizontal plane (the X-Y plane of FIG. 1), which is substantially perpendicular to the movement plane (the X-Z plane of FIG. 1) of nozzle assembly 110. Although utilizing a platen 210 dimensioned at 8″×11″ may at times prove advantageous, other sizes and dimensions are contemplated as well. Moreover, work surface/platen 210 need not be a solid surface and need not be perfectly planar. Work surface/platen 210 is essentially unrestricted in regard to form and composition so long as it is capable of moving a model/work piece 90 back and forth along the Y axis, and provides sufficient support for a work piece/model 90 being formed while selective deposition and movement of nozzle assembly 110 and platen 210 occurs.

Support assembly 300 is used to couple the various portions of device 10 together. Support assembly 300 is preferred to both provide a suitably stable support for device 10, to help protect device 10, and to help protect passers by from device 10.

Methods

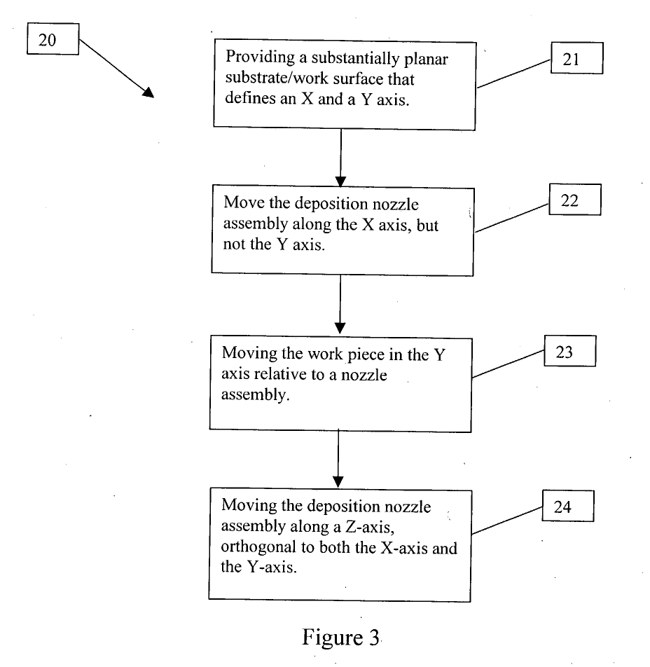

FIG. 3 depicts steps in a method 20 of creating a three-dimensional work piece (such as model 90) using selective deposition. In step 21 a substantially planar substrate/work surface (e.g. platen 210) is provided, that defines an X and a Y axis. In step 22 a deposition nozzle assembly (110) is moved along the X axis, but not the Y axis. Some embodiments may utilize two or more nozzles and/or nozzle assemblies. Deposition in any given movement may be unbroken, but is more likely to occur in discreet segments so that the nozzle deposits several separated segments of build material. In step 23 the work piece is moved in the Y axis relative to the nozzle assembly 110, and steps 22 and 23 are repeated, preferably until an entire layer is completed. In step 24 the deposition nozzle assembly (110) is moved along a Z axis, orthogonal to both the X axis and the Y axis. Movement in the X-Z plane is facilitated by a nozzle horizontal movement assembly 120, and a nozzle vertical movement assembly 130. At the new nozzle height, steps 22 and 23 are repeated. Step 24 is repeated (and corresponding steps 22 and 23) until the model 90 is complete.

Additional contemplated steps include: irradiating the material with emissions from a diode; forming a layer of the three-dimensional object by extruding a plurality of substantially different materials upon a substrate; solidifying selectively deposited material by at least one of radiation, laser cure, and heat; providing a plurality of print heads which may extrude different material; storing each of a plurality of substantially different materials in different reservoirs and printing the materials using one print head; using a guide to limit movement of a print head to movement in a vertical plane, or to limit movement of the work surface to movement along a single horizontal axis.

Particular methods are contemplated for producing coated objects. In such methods it is contemplated to produce a bottom by repeatedly depositing thin layers of a coating material, producing sides by repeatedly depositing a thin layer of the coating material around a thin layer of the coating material, depositing an active material inside the sides, and then producing a top by repeatedly depositing thin layers of the coating material. Such methods can advantageously be used to deposit a drug, or for example a liquid or gelled electrolyte.

In other embodiments, the methods described herein can be used to deposit a pure metal or other material that results from a chemical reaction of two or more precursor materials. This can be accomplished by depositing the precursor materials and reacting them either during or after deposition. Since multiple layers are contemplated, it is thought to be particularly desirable where the curing process is at least 90% complete within 5 seconds of the step of depositing, and in such instances it may be desirable to include a catalyst.

In some or all of these methods a computer representation or “model” of the object to be formed can be advantageously generated using a CAD/CAM software system. The software then preferably generates an STL file, and the STL file is converted into “slice” data corresponding to vertical cross-sectional patterns of the object. Of course, the CAD model need not be a perfect representation of the object, and the slice data and cross-sectional patterns need not be perfect representations of the CAD model. Instead, each of these need only be “derived” in part from its source. It is particularly contemplated, for example, that dimensions may be scaled to produce a scaled-up or scaled-down product, or to compensate for shrinkage or other processing factors. In such scaling-up it may be preferable to compensate for the change in distance from the light source to the uppermost layer of build material as the build grows by modifying the projected image, rather than moving either the build or the light source.

The term “CAD” is used herein in its broadest sense to include all manner of computer aided design systems, including pure CAD systems, CAD/CAM systems, and the like, provided that such systems are used at least in part to develop or process a model of a three-dimensional object.

Build Materials

The term “build material” is used herein to mean any material that is deposited in a layer-by-layer fashion to construct the three-dimensional object. This definition expressly excludes structures that are not added in a layer-by-layer fashion, such as central or peripheral supports that may be incorporated during some aspect of the fabrication process. As taught herein, multiple build materials may be included in the fabrication of a single three-dimensional object, to form support structures, conductive paths, and so forth.

All suitable build materials are contemplated, and there is an enormous number of such materials. Preferred materials are those having desirable viscosity to facilitate easy management from the reservoir container to the nozzle, are readily dried or cured, and have suitable hardness, conducting, insulating or other properties after curing. It is also contemplated that non- materials may also be used, such as where the systems and methods described herein are used to create a battery having a liquid or gelled electrolyte, and an edible food or drug substance having a liquid or gelled core.

Presently preferred build materials suitable for the bulk of the product being produced include polymerizable silazane, silane, borazine, borane oligomers, and other preceramic monomers, oligomers, or polymers functionalized by polymerizable groups (e.g., vinyl, acrylate, methacrylates, and so on); metal acrylates, metal methacrylates and other polymerizable metal carboxylates; metal carboxylate in the presence of oxidizing species and metal nitrates in the presence of reducing species. Such materials are selected because of their ability to be chemically transformed into ceramics, such as metal nitrides, carbides or oxides, or metals by heating, and for some of them, because of their ease of polymerization. These build materials may or may not be used in combination with other curable monomers or oligomers. Among other suitable build materials, it is contemplated that copper formate and gold acetate-isobutyrrate would be particularly well suited for providing an electrical conduction path, silver acrylate and Pd(CHOCOO)(CH₂OHCOO) would be particularly well suited for providing a thermal conduction path, silizanes and silanes would be particularly well suited for providing structural support, and zirconium and aluminum acrylates would be particularly well suited for providing barrier coatings and a surface compressive stress layer. Additionally, layers containing these and other materials may advantageously have different coefficients of thermal expansion than other layers.

The term “metal” is used herein to mean an element selected from one of the metal and transition metal groups of the periodic table. Since metals can be present in many different forms, however, the form of the element is determined by the context. Thus, when referring to “metals and alloys”, the term metal means a composition consisting substantially of metal and transition metal elements. When referring to “metal and alloy composites”, the term metal means a composition consisting substantially of one or more metal and transition metal elements, along with some non-metallic composition such as a ceramic. When referring to metals having a covalent bond, the term metal means an element selected from one of the metal and transition metal groups, and which is covalently bound to a non-metal.

The term “covalent bond” is used herein to mean any chemical bond other than a purely ionic bond. Covalent bonds thus include ordinary organic bonds such as the carbonhydrogen and carbon-oxygen bonds in a sugar, and also include the metal-ligand bonds in a coordination complex, such as NiCl₂ (pyridine)₄.

There are numerous products that can be manufactured using only one type of material. For example, a lever or other mechanical device can be manufactured using only a metal, only a plastic, or only a ceramic. Also, printers often print substantially two dimensional images (having thicknesses of less than 10s of microns) containing different colored inks, each of which contain a combination of plastics, solvents, drying agents, curing agents, and perhaps several other components. But the different colors of inks are not considered to be “substantially different materials” herein because the combinations are all merely different versions of the same thing—inks.

There are other types of products, including for example electronic devices, which require deposition of substantially different materials, deposited using multiple different print heads. Thus, one print head may deposit a metal or metal precursor, while other print heads may deposit plastics, ceramics, and so forth.

Products

It is contemplated that an extremely wide range of devices can be produced using the technologies described herein. From a functional standpoint, such devices can include batteries, capacitors, fuel cells, and other power supplies; electronic devices such as switches, transmitters, receivers, and processors; mechanical devices including levers and toggles; prototypes of larger or smaller devices; coated enclosures including pharmaceutical or food capsules and pills; and so forth. From a materials standpoint the manufactured devices can include ceramics, metals, plastics, and composites.

The term “cross-sectional pattern” is used herein to mean a representation of a cross-section of the object being built. Generally speaking, the cross-sectional pattern will be a complete vertical cross-section, because most builds are contemplated to be produced one complete layer at a time, in a vertical, stepwise fashion. Nevertheless, it is also contemplated that partial cross-sections could be employed, such as to accommodate different build materials. In addition, it is contemplated that non-vertical cross-sections could be employed so that the object being built would be constructed sideways, or in some other non-vertical manner. Non-vertical builds might, for example, be employed advantageously to provide extra strength in a particular direction.

Thus, specific embodiments and applications of rapid prototyping systems and methods utilizing a print head/nozzle assembly that moves vertically relative to a work surface have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of creating a three-dimensional object using selective deposition, comprising:
providing a substantially planar substrate defining an X and a Y axis;
moving a print head back and forth in the X axis, not the Y axis; and
moving the print head back and forth in a Z axis, orthogonal to both the X axis and the Y axis.

2. The method of claim 1, further comprising moving the substrate in the Y axis.

3. The method of claim 1, further comprising the step of printing an entire layer of the three dimensional object before printing a subsequent layer.

4. The method of claim 1, further comprising at least one additional print head moving in the X axis and in the Z axis, not in the Y axis.

5. The method of claim 1, further comprising the step of extruding a material and curing the material within 5 seconds of extruding.

6. The method of claim 5, wherein the step of curing includes irradiating the material with emissions from a diode.

7. The method of claim 1, further comprising depositing a plurality of substantially different materials from a plurality of print heads.

8. The method of claim 7, wherein each of the substantially different materials is solidified by at least one of radiation, laser cure, and heat.

9. The method of claim 7, wherein each of the substantially different materials is deposited from a different one of the plurality of print heads.

10. The method of claim 7, further comprising storing each of the substantially different materials in a different reservoir.

11. The method of claim 7, wherein the substantially different materials are selected from the group comprising a metal, a ceramic, and a plastic.

12. The method of claim 1, further comprising a guide that inhibits the print head from movement in the Y axis.

13. The method of claim 1, further comprising a guide that limits movement of the substrate to the Y axis.

14. The method of claim 1, wherein the object comprises at least one of a metal, a ceramic, and a plastic.

15. The method of claim 1, further comprising:
producing a bottom by repeatedly depositing thin layers of a coating material;
producing sides by repeatedly depositing a thin layer of the coating material around a thin layer of the coating material;
depositing an active material inside the sides; and
producing a top by repeatedly depositing thin layers of the coating material.

16. The method of claim 1, further comprising:
depositing at least two materials onto a substrate to form a layer; and
reacting the materials at least partly as a function of a curing process.

17. The method of claim 16, wherein the step of reacting further comprising adding a catalyst.

18. The method of claim 16, wherein the curing process is at least 90% complete within 5 seconds of the step of depositing.

19. A three dimension deposition system comprising:
a work surface adapted to move along a first axis; and
a material deposition head adapted to move along a second axis and a third axis while depositing material on the work surface; wherein
movement along the third axis involves a change in the distance between the work surface and the material deposition head; and wherein
the first, second, and third axis are orthogonal.
